(19) United States
(12) Patent Application Publication
(10) Pub. No.: US 2016/0221389 A1
(43) Pub. Date: Aug. 4, 2016

(54) HI-RAIL WHEEL

(71) Applicant: Weld Racing, LLC, Kansas City, MO (US)

(72) Inventor: Nick Rickels, Kansas City, MO (US)

(73) Assignee: Weld Racing, LLC, Kansas City, MO (US)

(21) Appl. No.: 15/014,555

(22) Filed: Feb. 3, 2016

Related U.S. Application Data
(60) Provisional application No. 62/111,456, filed on Feb. 3, 2015.

(51) Int. Cl. B60B 19/02; B60B 3/02; B60B 21/10; B60B 3/00; B60B 21/02; B60B 21/04

(52) U.S. Cl. CPC B60B 19/02; B60B 21/023; B60B 21/04; B60B 21/108; B60B 3/008; B60B 3/02; B60B 2900/351; B60Y 2200/10; B60Y 2200/30

(57) ABSTRACT

A hi-rail wheel that may be mounted on the OEM lugs, and provides a smooth ride at highway speeds, better handling and improved tire wear and life. The wheel is mounted to the OEM lugs using the OEM lug nuts eliminating extra lug nuts, an adapter plate, and requiring only one wrench size for removal and mounting of the wheel. Additionally, the wheel may be 40-80 pounds lighter per wheel than the prior art hi-rail wheels and adapters.

### CROSS REFERENCE TO RELATED APPLICATION

This application claims the benefit of co-pending application Ser. No. 62/111,456 filed Feb. 3, 2015, entitled HI-RAIL WHEEL.

### FIELD

The present invention relates to mounting wheels on vehicles and, more particularly, to a wheel and adapter that effectively decreases the distance between tires of the vehicle to facilitate the use of the vehicle on a railroad track.

### BACKGROUND

The concept of using a wheel adapter is not new. A typical purpose of a wheel adapter is to install a wheel that is a different size than the original equipment manufacturer's wheel for a particular vehicle. To accommodate a different wheel size, wheel adapters may be used. The wheel adaptor allows installation of a wheel that has a different bolt pattern, that has a different tire size, that increases the tire track (center to center of tire), or that converts a single rear wheel to a dual rear wheel. In each of these applications, the final position of the wheel and associated tire is moved outwardly of the original position.

In situations where it is desired to decrease the tire track, such as for use on a railroad track, the reduction in the tire track typically has an undesirable affect on the riding and handling characteristics of the vehicle. When the wheel and tire sets of the front end suspension are moved inwardly, the turning radius of the vehicle is restricted due to interference between the tire and the frame and/or the brake calipers of the vehicle. In certain vehicles, it is required that the tire track be reduced to allow the tires of the vehicle to be properly positioned on a railroad track.

For a railroad application, the tire size is typically increased from 16 inches to 19.5 inches, which is the maximum size allowable to ensure for adequate clearances between the tire and the fenders of the vehicle. The normal offset of the 16-inch wheel is 0.50 inches. To allow the tire to ride on a railroad track, a special wheel is required that has enough clearance to clear a brake caliper or use a deep offset rim such as, for example; a five-inch offset, and use an adapter to bring the rim and tire to the final desired position.

A prior art different-sized wheel that allows a single rear wheel track, such as a one-half-ton, three-quarter-ton, or single rear wheel one ton truck, that will interchange with the given wheel mounted on a wheel hub and allow the tire to be positioned on railroad track, requires a wheel adapter. The prior art wheel adapter provides the option of mounting a wheel of a different size and wheel track than the wheel originally supplied with the vehicle. Typically these prior art wheels and wheel adapters include a wheel hub with eight mounting studs and an adapter plate with eight mounting studs. The adapter plate is secured to the wheel hub by eight lug nuts received by the eight wheel hub mounting studs. The wheel is then secured to the adapter plate by eight tug nuts received by the eight adapter plate mounting studs. The additional weight of the wheel, wheel hub, mounting studs and lug nuts contribute to vibrations, excessive/uneven tire wear, poor handling, and maintenance issues. Further, the wheel hub lug nuts are typically smaller than the adapter plate lug nuts, requiring two wrench sizes for installation and removal of the wheel.

### SUMMARY

The present invention provides a hi-rail wheel that may be mounted on the OEM lugs. The present invention provides a smooth ride at highway speeds, better handling and improved tire wear and life. The wheel is mourned to the OEM lugs using the OEM lug nuts eliminating 32 extra lug nuts and requiring only one wrench size for removal and mounting. Additionally, the wheel may be 40-80 pounds lighter per wheel than the prior art hi-rail wheels and adapters.

### BRIEF DESCRIPTION OF THE DRAWINGS

The above, as well as other objects, features, and advantages of the present invention will be understood from the detailed description of the preferred embodiments of the present invention when considered in the light of the accompanying drawings, in which:

FIG. 1 is a front elevational view of a lathe form wheel of the present invention;

FIG. 2 is a sectional view taken along line 2-2 of the wheel illustrated in FIG. 1;

FIG. 3 is a front elevational view of a machined wheel of the present invention;

FIG. 4 is a sectional view taken along line 4-4 of the wheel illustrated in FIG. 3;

FIG. 5 is a detail view taken along line 5 of the sectional view of FIG. 4.

FIG. 6 is a front perspective view of the wheel illustrated in FIG. 3; and

FIG. 7 is a rear perspective view of the wheel illustrated in FIG. 3.

### DETAILED DESCRIPTION

As required, detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Moreover, except where otherwise expressly indicated, all numerical quantities in this description and in the claims are to be understood as modified by the word “about”(0 in describing the broader scope of this invention. Practice within the numerical limits stated is generally preferred. Also, unless expressly stated to the contrary, the description of a group or class of materials as suitable or preferred for a given purpose in connection with the invention implies that mixtures or combinations of any two or more members of the group or class may be equally suitable or preferred.

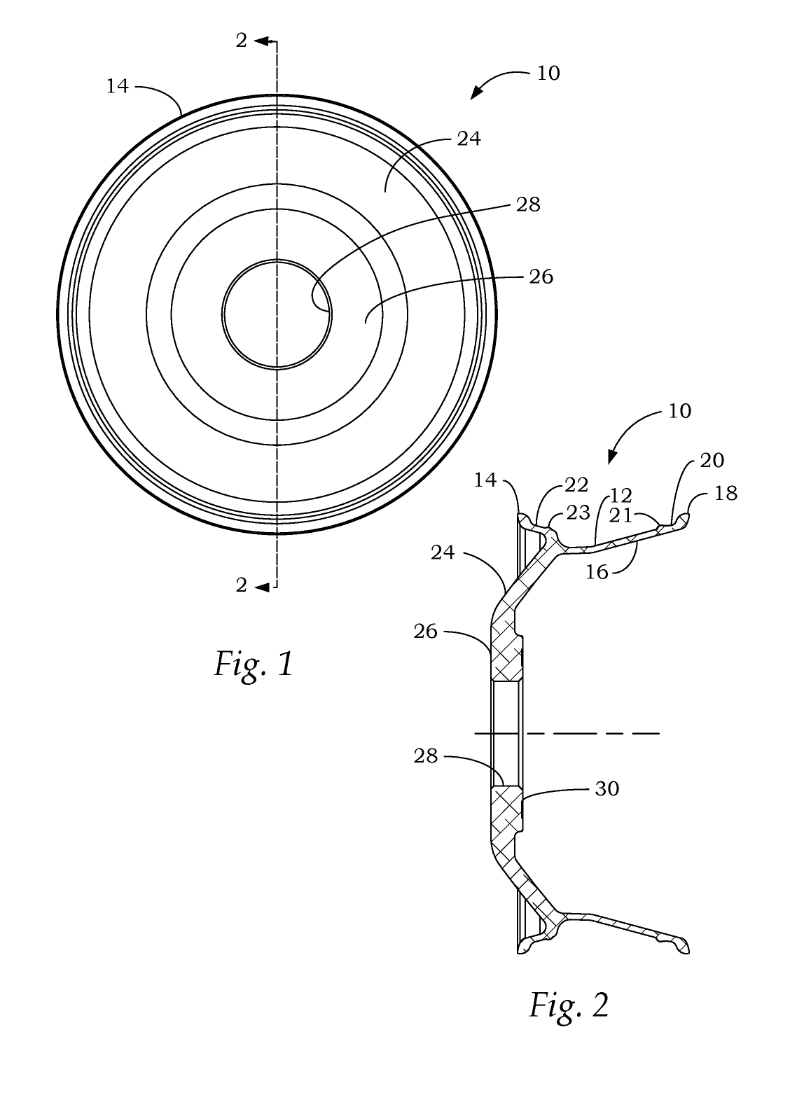

Referring initially to FIGS. 1 and 2, a lathe form of the present invention is generally indicated by reference 10. Wheel 10 is forged and machined from a single piece of aluminum, or other alloy forging to create a wheel that is stiff, strong and lightweight. The wheel 10 may have a diameter of 16 to 24 inches, and preferably 19.5 to 20 inches. The wheel 10 includes an annular rim 12 with an outer flange 14, a barrel 16 and an inner flange 18. Inner flange 18 and outer flange 14 each include a bead seat 20 and 22, and optionally safety humps 21 and 23, respectively, which cooperate with the heads of a tire (not shown) to create an air tight seal between the rim 12 and the associated tire. The angle of the bead seals may be between 5 and 15 degrees.

The barrel 16 extends in a generally frusto-conical shape to an outer web 24, a wheel face 26 and terminates at a center bore 28 for receiving an axle hub (not shown). Wheel face 26 lies in a first plane at the outer extent of the wheel 10, which is parallel to a second plane in which outer flange 14 lies, inside of the first plane, and a third plane at the inner extent of the wheel 10 in which inner flange 18 lies. The first plane may be spaced 0.5 to 2.0 inches from the second plane, for example. On the inside surface of wheel face 26 is a back pad 30.

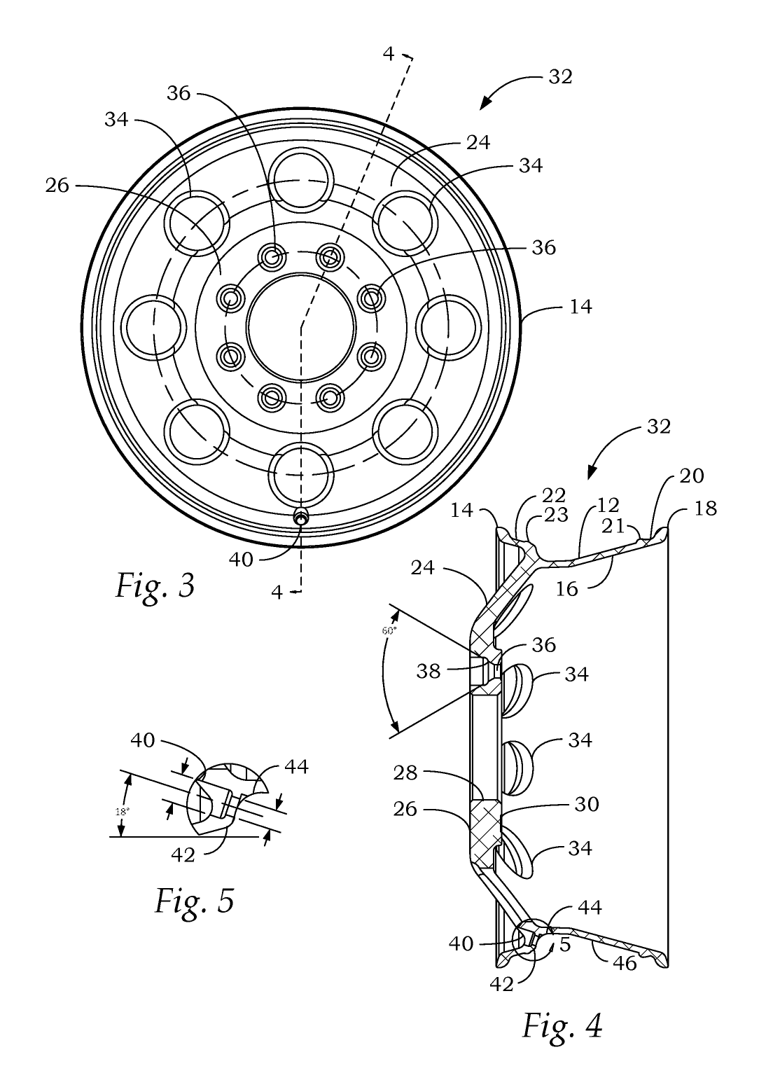

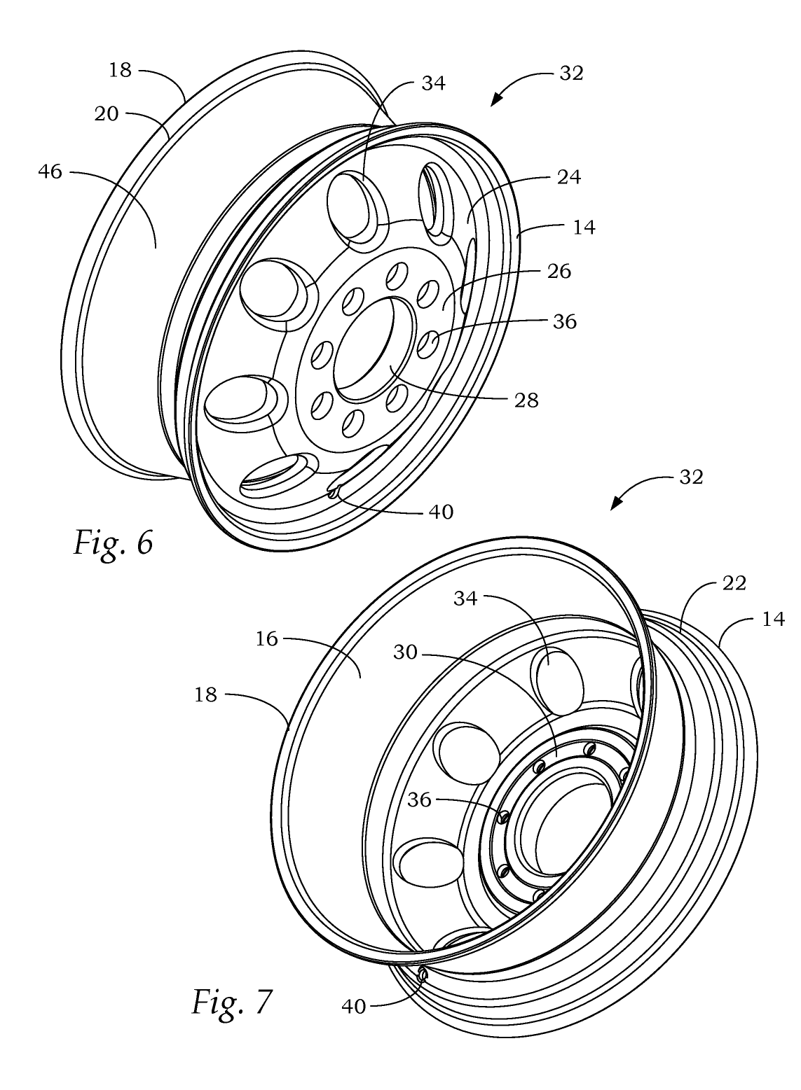

Referring to FIGS. 3-7, a forged wheel with additional machining is generally indicated by reference numeral 32. Wheel 32 includes apertures 34 machined through the outer web 24 removing material to lighten the wheel 10 and to provide ventilation to the motor and brakes (not shown) of the vehicle to which the wheel is mounted. An annular array of lug apertures 36 are machined through the wheel face 26 and the back pad 30. Lug apertures 36 are arranged to receive threaded studs (not shown) extending outwardly from a wheel hub (not shown). Each lug aperture 36 maybe countersunk 38 on the wheel face 26 side of the lug aperture 36 to receive a lug nut for engaging a corresponding threaded stud to secure the wheel 32 to the wheel hub of the vehicle. A valve stem hole 40 is machined at an angle of approximately 18 degrees relative to a plane perpendicular to the second plane, and through a material radius 42 in the web 24 to a well 44 on the tire side surface 46 of the web 16 to receive a valve stem (not shown).

It is to be understood that while certain now preferred forms of this invention have been illustrated and described, it is not limited thereto except insofar as such limitations are included in the following claims.

Having thus described the invention, what is claimed as new and desired to be secured by Letters Patent is as follows:

1. A wheel for mounting to a vehicle having an annular array of spaced apart wheel mounting studs and an axle hub, comprising:
an annular rim having an outer flange, an inner flange and a barrel extending therebetween;
an outer web extending inwardly from said barrel to a wheel face;
said wheel face having an annular array of spaced apart stud apertures axially aligned with and adapted to receive the annular array of spaced apart wheel mounting studs, and a center bore adapted to receive the axle hub;
said wheel face tying in a first plane:
said outer flange lying in a second plane parallel to said first plane;
said inner flange lying in a third plane parallel to said first plane; and
said second plane extending in between said first plane and said third plane.

2. The wheel of claim 1 wherein said first plane of said wheel face is spaced approximately 0.5 inch from said second plane of said outer flange.

3. The wheel of claim 1 wherein said first plane of said wheel face is spaced between 0.5 and 2 inches from said second plane of said outer flange.

4. The wheel of claim 1 wherein said outer web includes a plurality of spaced apart apertures.

5. The wheel of claim 1 wherein said inner flange and outer flange each include a bead seat.

6. The wheel of claim 5 wherein each of said bead seats includes a safety hump.

7. The wheel of claim 1 wherein said wheel is forged.

8. The wheel of claim 1 having a diameter between 18 and 24 inches.

9. A wheel for mounting to a vehicle having an annular array of spaced apart wheel mounting studs and an axle hub, comprising:
an annular rim having an outer flange, an inner flange and a barrel extending therebetween;
an outer web extending inwardly from said barrel to a wheel face and having a plurality of spaced apart apertures extending from an outer surface to an inner surface;
said wheel face having an annular array of spaced apart stud apertures axially aligned with and adapted to receive the annular array of spaced apart wheel mounting studs, and a center bore adapted to receive the axle hub;
said wheel face lying in a first plane;
said outer flange lying in a second plane parallel to said first plane;
said inner flange lying in a third plane parallel to said first plane; and
said second plane extending in between said first plane and said third plane.

10. The wheel of claim 9 wherein said first plane of said wheel face is spaced approximately 0.5 inch from said second plane of said outer flange.

11. The wheel of claim 9 wherein said first plane of said wheel face is spaced between 0.5 and 2 inches from said second plane of said outer flange.

12. The wheel of claim 9 wherein said inner flange and outer flange each include a bead seat.

13. The wheel of claim 12 wherein each of said bead seats includes a safety hump.

14. The wheel of claim 9 wherein said wheel is forged.

15. The wheel of claim 9 having a diameter between 18 and 24 inches.

16. A wheel for mounting to a vehicle having an annular array of spaced apart wheel mounting studs and an axle hub, comprising:
an annular rim having an outer flange, an inner flange and a barrel extending therebetween, said outer flange and said inner flange each having a bead seat;
an outer web extending inwardly from said barrel to a wheel face and having a plurality of spaced apart apertures extending from an outer surface to an inner surface;
said wheel face having an annular array of spaced apart stud apertures axially aligned with and adapted to receive the annular array of spaced apart wheel mounting studs, and a center bore adapted to receive the axle hub;
said wheel face lying in a first plane;
said outer flange lying in a second plane parallel to said first plane;
said inner flange lying in a third plane parallel to said first plane; and
said second plane extending in between said first plane and said third plane.

17. The wheel of claim 16 wherein said first plane of said wheel face is spaced approximately 0.5 inch from said second plane of said outer flange.

18. The wheel of claim 16 wherein said first plane of said wheel face is spaced between 0.5 and 2 inches from said second plane of said outer flange.

19. The wheel of claim 16 wherein said wheel is forged.

20. The wheel of claim 16 having a diameter between 18 and 24 inches.
